(19) United States
(12) Patent Application Publication
(10) Pub. No.: US 2003/0163373 A1
(43) Pub. Date: Aug. 28, 2003

(54) Device for receiving advertising data and method of application

(76) Inventor: Vlady Cornateanu, Los Angeles, CA (US)

Correspondence Address: SOFER & HAROUN, L.L.P., Suite 910, 317 Madison Avenue, New York, NY, 10017, US

(21) Appl. No.: 10/349,329

(22) Filed: Jan. 22, 2003

Related U.S. Application Data
(62) Division of application No. 09/343,866, filed on Jun. 30, 1999.

(51) Int. Cl. G06F 17/60

(52) U.S. Cl. 705/14

(57) ABSTRACT

An embodiment of this invention is for a portable, wireless data storage device for receiving, scanning, storing and transmitting data, comprising data storage means for storing data and a number of computer software programs; computer software executing means for executing said computer software programs; a wireless receiving means for receiving electronic data sent via an electronic medium, including radio waves or the Internet; a display means coupled to said computer software executing means for displaying said electronic data; a universal product code scanning means coupled to said computer software executing means for scanning a universal product code and for interpreting the data encoded by said universal product code; and downloading means coupled to said computer software executing means for downloading data to another computer or data receiving terminal.

Another embodiment of the portable wireless, data device of this invention comprises means for receiving electronic ticket data wherein electronic ticket data are sent via an electronic medium, including radio waves or the Internet and stored in data storage means; means for displaying an acknowledgment that electronic ticket data have been received; and means for downloading said electronic ticket data to another computer or data receiving terminal.

This is a divisional application that claims the priority of the parent U.S. patent application Ser. No. 09/343,866 filed on Jun. 30, 1999 and tilted as “DEVICE FOR RECEIVING ADVERTISEMENT DATA AND METHOD OF APPLICATION.”

### BACKGROUND OF THE INVENTION

1. Field of Invention

The present invention relates to a new portable wireless data storage device and method which enables a customer to store data from retail coupon advertising, special event ticketing, or the like, wherein such data is received via radio waves and the like, such data is sent from a manufacturer, retailer, ticket issuer, or the like, and the data is transmitted to an end user data receiving terminal for further data processing.

2. Background of Invention

Today's approach for distributing retail coupon advertising is primarily through the newspaper media and bulk-rate mass mailing.

The consumer response to coupon advertising and mass mailing is small and redemption rates are very low when compared to the expense incurred by the advertiser. Also, the advertiser does not receive any marketing information regarding the consumers who are redeeming their coupons, such as consumer buying patterns. This information is of key importance for future targeting of consumer advertising by the manufacturer, retailer, or advertiser, because effective advertising depends on knowing the buying needs of your consumer.

Collecting retail advertising coupons from national, local and regional newspapers as well as collecting advertising mass mailings sent from all over the nation is a monumental task for the consumer. Distribution of coupons and bulk-mailed advertising is also very expensive for manufacturers, retailers, and advertisers.

The process for obtaining coupons is time consuming, cumbersome, and creates a disincentive to the consumer for using this type of marketing. Coupons must be cut out of newspapers and bulk-mailed advertising and organized in a folder by category. Then, the coupon's expiration dates must be frequently checked. This process is an anachronism in today's fast-paced technological world, particularly as we enter the 21^{st} century.

The trip to the supermarket to redeem the coupons also creates another hurdle to a customer who seeks to redeem retail coupons. A shopper must first locate the desired item in the store, then search in the coupon folder to see if there is a corresponding coupon for the item they want to buy. This process unnecessarily wastes a lot of time. Nevertheless, millions and millions of people go through this process in order to use coupons to save money on the items they select for purchase.

From the advertiser's point of view, placing retail coupons and advertisements in thousand of newspapers nationwide and bulk mailing millions of advertising coupons across the country is a monumental and expensive task.

In a very short period of time, the device of this invention will be as useful and popular as cellular phones or wireless pagers. Eventually, any type of advertising may utilize the wireless device and method of this invention.

A similar inefficiency exists in distribution of tickets for sporting events, travel, and the like.

We can easily see how cellular telephones, wireless pagers, and the Internet have impacted our daily lives. Today, approximately five hundred million cellular phones and pagers are in operation worldwide, with an expected 1 billion by year 2004. Internet E-mail is also growing rapidly. This explosion in popularity is surprising, when we look back only to 1990 when the cellular phone and e-mail were mere novelties and the Internet was virtually unknown. People's lives have changed dramatically due to the advent of cellular phones, pagers and E-mail.

These inefficiencies could be eliminated by the device and method of this invention which incorporate all of the facets of distributing and redeeming retail coupons and bulk mailed advertising as well as special event ticket selling, distribution and collection. The device and method disclosed herein will certainly improve, if not radically change, the way people shop and utilize coupon advertising and special event ticketing.

### SUMMARY OF THE INVENTION

An embodiment of this invention is for a portable, wireless data storage device for receiving, scanning, storing, transmitting and downloading data, comprising data storage means for storing data and a number of computer software programs; computer software executing means for executing said computer software programs; a wireless signal communications means coupled to said computer software executing means for receiving electronic data sent via radio waves, the Internet, and E-mail; a display means coupled to said computer software executing means for displaying said electronic data; a universal product code scanning means coupled to said computer software executing means for scanning a universal product code and for interpreting the data encoded by said universal product code; and downloading means coupled to said computer software executing means for transmitting data to another computer or data receiving terminal.

Another embodiment of this invention is a portable, wireless data storage device having a computer software program which comprises receiving electronic data mode means for receiving a command to receive said electronic data via radio waves, the Internet, or E-mail, and for causing said computer software executing means to issue a command to said wireless signal communications means to cause said wireless signal receiving means to receive and store said electronic data in said data storage means; scanning mode means for receiving a command to scan items and for causing said computer software executing means to issue a command to said universal product code scanning means to cause said universal product code associated with said item to be scanned and for said data encoded by said universal product code to be received and stored in said data storage means; comparing data mode means for comparing said stored universal product code data with said stored electronic data, and for causing said computer software executing means to issue a command to said display to indicate whether said stored universal product code data for said item scanned matches the stored electronic data; price calculating means for calculating the price of said item scanned based upon whether said stored universal product code data for said item scanned matches the stored electronic data; price displaying means for causing said computer software executing means to issue a command to said display to present said price of said item scanned; and downloading mode means for receiving a command to download said price of said item scanned and said universal product code data, and for causing said computer software executing means to issue a command to said downloading means to cause said downloading means to download said universal product code data and said price of said item scanned to another computer or data receiving terminal.

Still another embodiment of this invention portable, wireless data storage device comprises an input data means coupled to said computer software executing means for data receiving input by a user and for transmitting said user input data to said computer software executing means; user input data mode means for receiving a command to receive said data input by said user and for causing said computer software executing means to issue a command to said data storage means to cause said data storage means to receive and store said input data in said data storage means; display user input mode means for receiving a command to display said data input by said user, and for causing said computer software executing means to issue a command to said display means to cause said display means to display said data input by said user; and download user input mode means for receiving a command to transmit said data input by said user, and for causing said computer software executing means to issue a command to said transmitting means to cause said transmitting means to transmit said data input by said user to another computer or data receiving terminal.

Still another embodiment of this invention includes a method of application for the portable, wireless data storage device comprising receiving electronic ticket data wherein electronic ticket data are sent via radio waves, the Internet, or E-mail and stored in data storage means; displaying an acknowledgment that electronic ticket data has been received; and downloading said electronic ticket data to another computer or data receiving terminal.

### BRIEF DESCRIPTION OF THE DRAWINGS

A better understanding of this invention may be obtained when the detailed description of this invention which follows is considered in conjunction with the following drawings, in which:

FIG. 1 is a frontal view of the wireless device of this invention.

FIG. 2 is a back view of the device of FIG. 1.

FIG. 2A is a block diagram of the data and information processing of device 10.

FIG. 3A is a partial view of a retail store.

FIG. 3B is a partial view of a product area in an aisle of a retail store. Products are shown having a UPC label and there is a corresponding UPC shelf label shown.

FIG. 3C shows electronic coupon information being sent by wireless signal.

FIG. 3D shows a paper coupon having a UPC label, a coupon name, and discount amount.

FIG. 3E shows a checkout counter having a checkout station, a UPC reader, and a display.

FIG. 4 shows a flowchart for the method of using the wireless device of this invention for Electronic Coupons Transfer (ECT).

FIG. 5 shows a flowchart for the method of using the wireless device of this invention for Electronic Tickets Transfer (ETT).

### BRIEF DESCRIPTION OF THE INVENTION

The device and method of this invention is directed toward a new, portable wireless electronic shopping device, approximately the size of a cellular phone, which is capable of receiving, storing, and transmitting retail coupon advertising and other data. The device and method incorporates new wireless technologies in two ways.

First, the device is capable of receiving wireless data transmission developed under the Bluetooth technology, but is not limited to it. Bluetooth technology combines telecommunication and computer technologies to provide a low-cost, low-power radio wave-based cable replacement, or wireless link. Such a link may be used for short range radio wave-based communications for integration into small portable devices such as in the present invention. This technology also may be use for wireless voice and data handling in a small low cost device that may withstand interference from other sources in open band radio waves. Second, the device of this invention is capable of data receiving from a radio transmitter located at a manufacturer's and/or retailer's data transmission center or an independent service provider that coordinates all wireless and other data transmissions to the device units.

For advertising coupons, the device receives the data that is encrypted with product bar codes information in order to identify the product by category, item and manufacturer. A software program loaded within the device organizes and alphabetizes the coupon data by product category, item description and manufacturer (e.g. Shampoo/Neutrogena™/Hygine). This software will also track the expiration date of the coupon, and delete the coupon data upon expiration.

Each device is identified by a personal ID number, similar to a cellular telephone or pager number. This number may be registered through vendors or directly by the manufacturers and/or retailers who are responsible for transmitting the retail coupons advertising data to the devices.

When data is transmitted from the device to an end user (supermarket, manufacturer or the like), the ID number, along with the consumer demographic information, are entered into a database. As consumers redeem their coupons, the manufacturers and retailers build up their database and use these data in future targeting of the customers that redeem their coupons and use their respective products.

The device of this invention has scanning capabilities to permit the consumer to scan their coupons from the newspaper or bulk-mailed advertising. Also, this device may scan or receive information downloaded from the Internet or from Internet E-mail transmissions. The scanned information may be received, stored, and transmitted by the device in a similar manner as data received from wireless transmissions. Identical coupons may not be scanned twice, as the device will reject identical coupon information, based on the product bar code.

Also, the device has the capability of deleting unwanted or unneeded coupons received by wireless transmission or accidentally scanned, using a delete button. This capability will enable manufacturers and retailers to ascertain the frequency and extent to which a consumer utilizes their product, thus providing better marketing research data.

The method of using the device of this invention for advertising coupons is as follows. After the coupon data is stored via scanning or wireless transmission, the wireless device is used by the consumer to shop and redeem coupons at the retail store. The wireless device may also incorporate the consumer's affinity club ID number or other method of providing further discounts and customer loyalty. The consumer then proceeds through the aisles of the store, shopping with the device in hand, and scanning the product bar codes of the items to be purchased. After scanning a bar code of a particular item, the device will display, such as on LCD screen, whether a coupon is available. If a coupon is available, the LCD screen displays the coupon's value.

Prior to the shopping trip, the customer may type his or her shopping list on the device of this invention. When a coupon is detected by the device, a plus sign (+) will appear next to the item on the shopping list. If a coupon is not detected then a minus sign (−) will appear next to the item on the shopping list. As the customer progresses through the aisles of the store, the device will continuously show the completion process of the shopping list. If a Universal Product Codes (UPC) is scanned for an item that is not on the shopping list, the name of the item will automatically be added to the shopping list, with a + or − sign being displayed, depending upon whether a coupon for the item selected for purchase has been stored. Also, the price of such items will be retrieved from the stored UPC. A running total is calculated and displayed (including the discount on the coupons) of the items selected for purchase before the customer proceeds to the cash register terminal.

At the end of the shopping trip, a grand total of the items selected for purchase is displayed. The device of this invention is then attached to a cash register terminal. As the items purchased are scanned by the cashier at the terminal, the electronic coupon information from the device is transmitted to the terminal. After the last item is scanned by the cashier, the customer pays the bill and receives the usual receipt.

The data from the scanned coupons is transmitted to the retailer's data computer software executing center, as well as directly to the manufacturer's data computer software executing center, for credit. All the paper work associated with handling paper coupons is thus eliminated, saving many millions of dollars.

Initially, the retailers may provide the device to the customer free of charge, having already so loaded the device with a manufacturer's or retailer's coupons, the customer's ID number, and the supermarket ID number (for loyalty discounts).

The device is PC compatible so that coupons can be sent via Internet E-mail or downloaded via an Internet website and then directly downloaded and received by the device.

In another object of this invention, the device may be used to order and receive tickets for special events, such as for concerts, theater productions and any other activity that requires the mailing of a ticket, such as for travel in buses, trains or airplanes.

The method of using the wireless device of this invention for ticketing is as follows. A customer ordering a ticket calls a ticket issuer or service provider entity on the telephone (e.g. Ticket Master, or Continental airlines) and gives the customer's ID number and credit card or debit card information. The ticket issuer or service provider sends the information required to issue a ticket via wireless transmission or radio transmission to the device of this invention, instead of mailing out a ticket, after processing the credit or debit card information. The information sent to the device is received by the device exactly as transmitted by the issuer. The wireless device displays a “Received Ticket” (and name of event) message on the LCD screen when ticket information is received and stored into the device. The customer then takes the device to the event or to the travel venue for which the ticket was issued. The ticket information will be transmitted to the event's data receiving center, as well as directly to the ticket issuer data receiving center, for credit. This information may be transmitted by connecting the device to another device or scanned at the gate by the facility's scanner and removed from the device at the same time.

The device and method of this invention will eliminate all ticket scalping activities at high demand special events because the ID number associated with the ticket issuer or service provider must match exactly with the information stored in the device. Also, all the paper work associated with handling paper tickets is eliminated. Thus, money and time are saved for the mailing tickets and/or standing in line to buy tickets.

The device is PC compatible and tickets may be downloaded from the Internet or the information E-mailed by the ticket issuer or service provider. The customer will have access via the Internet to the configuration of the seating at the particular event. He or she may click on the desired seating arrangement, pay for the seat via an Internet website with the credit card of the device, and have the ticket transmitted directly to the device.

### DETAILED DESCRIPTION OF THE INVENTION

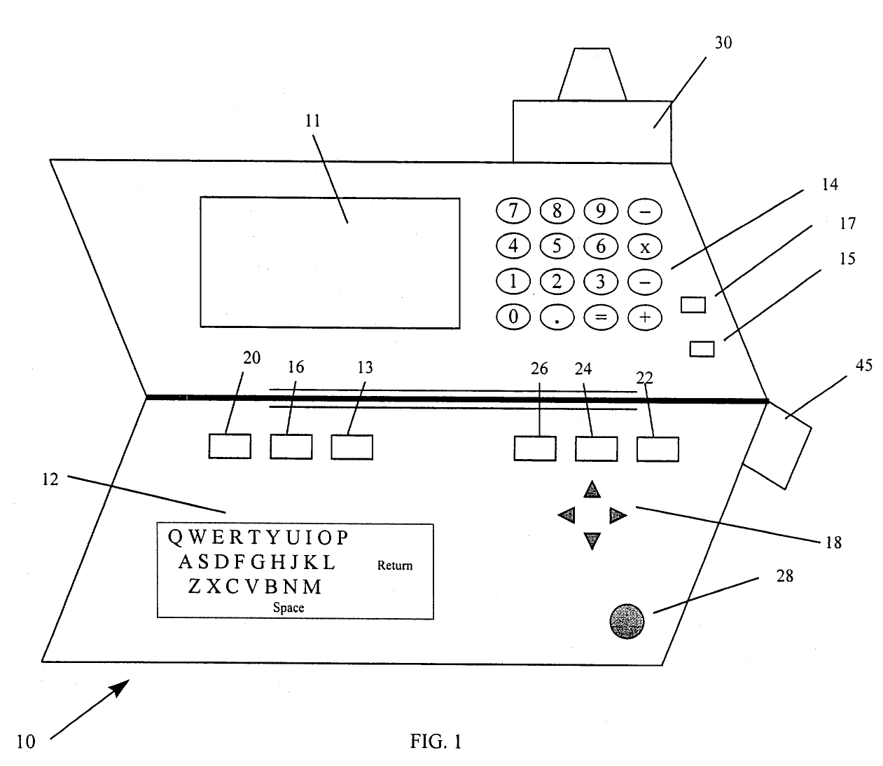

In FIG. 1, a front view of a wireless device 10 is shown. The wireless device 10 includes a display means 11, such as a liquid crystal display (LCD), for displaying information received, stored and/or transmitted to the wireless device 10. The display means 11 may be split into 2 screens via split screen button 15 so that a shopping list may be displayed next to the stored coupon data. Also, the display means 11 may be used to display the items stored in the memory of the wireless device 10. The wireless device 10 is further shown having an alpha keypad 12 and numeric keypad 14 for entering the name and/or price of an item to be purchased. The numeric keypad 14 may be used along with a calculator key 16 for the mathematical and calculator functions of the wireless device 10. The wireless device 10 has a search menu 18 to enable the consumer to scroll down the items stored in the memory of the wireless device 10 and items displayed in the display means 11. A series of buttons are shown on wireless device 10 for engaging various functions, such as for a calendar 20, an enter button 22 for storing items such as the price and description of an item in the memory of wireless device 10, an insert button 24 for entering alpha numeric data into the display means 11, a delete button 26 for deleting alpha and/or numeric data from the display means 11, an on/off/clear button 28 for starting up and shutting down the wireless device 10 and for clearing the alpha and/or numeric data in the display means 11, a view mode button 13 for viewing the stored coupon data and/or the shopping list. The wireless device 10 has receiving means 30 for data receiving by any electronic medium, including, but not limited to, wireless Bluetooth transmission, radio wave transmission, the Internet, Internet E-mail, or the like. The wireless device 10 has a receive button 17 for engaging the wireless means to receive electronic data.

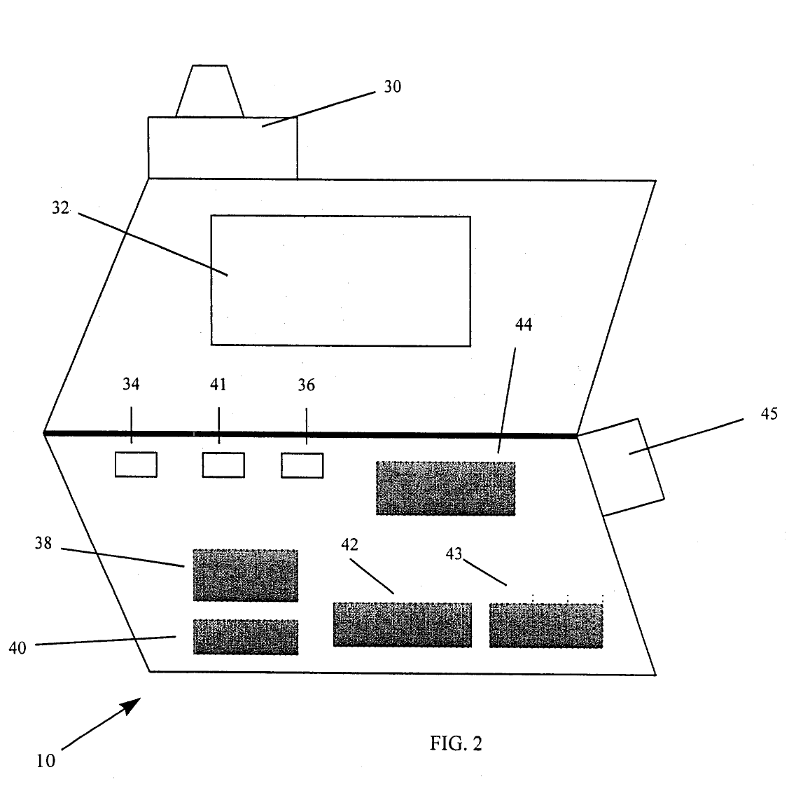

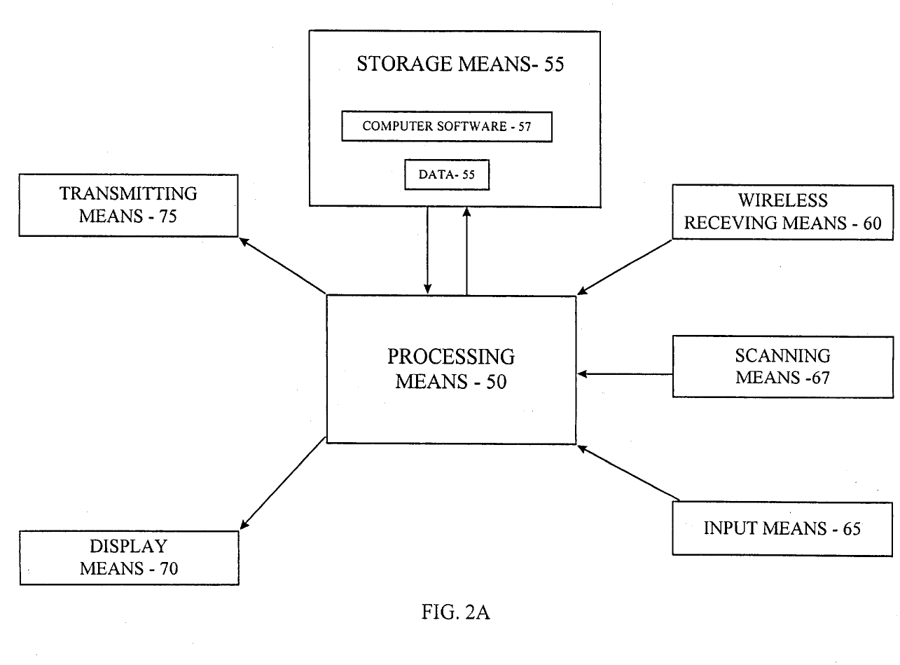

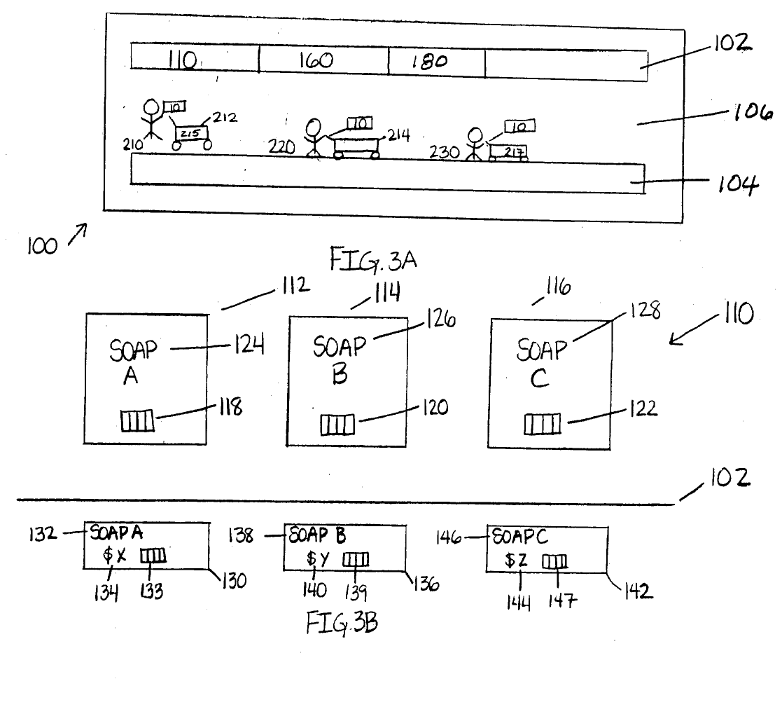

In FIG. 2, the back view of the wireless device 10 is shown having a scanning means 32 for scanning random paper coupons from newspapers, bulk-mailed advertising, sent via E-mail, and the like. The scanning means 32 may be used to scan the Universal Product Code (UPC) for an item. A scan button 34 is shown for operating the device in scan mode and is used in conjunction with the enter button 22 to store the scanned coupon data transmitted by manufacturer at the same time the device is in scanning mode, the coupons are stored in a buffer until the device returns to the receiving mode, at which time the coupons are stored in the memory of the device. The device 10 is further shown having a downloading button 36 which activates the transmission and down-loading of the data stored in the device 10 for the items selected by the customer to be purchased. A view mode button 41 for viewing the shopping list or the available electronic coupons stored in memory 42. Means for providing electrical power for device 10 is shown in FIG. 2 and may include a battery 38, secondary backup battery 40 and, an electrical wire (not shown) for receiving power from an electrical source. Also shown in FIG. 2 are memory chips 42 and sub memory chip 43 that are capable of storing all data received, scanned and/or being stored for transmission and downloading by the device. The computer software program for enabling the device to perform the above-referenced functions is also stored on memory chips 42. The computer software program is executed via central computer software executing unit 44. In addition, connection means 45 are provided to enable device 10 to be linked to a personal computer and to transfer or receive data.

In FIGS. 1 and 2, the wireless device 10 of this invention is shown capable of being folded in half along a centerline. In the folded position, device 10 may be operated in the scan mode to scan electronic coupons or to scan the UPC shelf label for the items selected for purchase.

FIG. 2A shows a block diagram of the processing of data and information in device 10. A computer software executing means 50 interacts with a data storage means 55, receives data from wireless receiving means 60, receives user input data from input means 65, scans UPC and sends encoded UPC data from scanning means 67, displays data via display means 70, and transmits and/or downloads data to downloading means 75. The data storage means 55 stores one or more computer software programs 57 and data 59. The computer software programs executes commands which enable the functions for the device 10 via the computer software executing means.

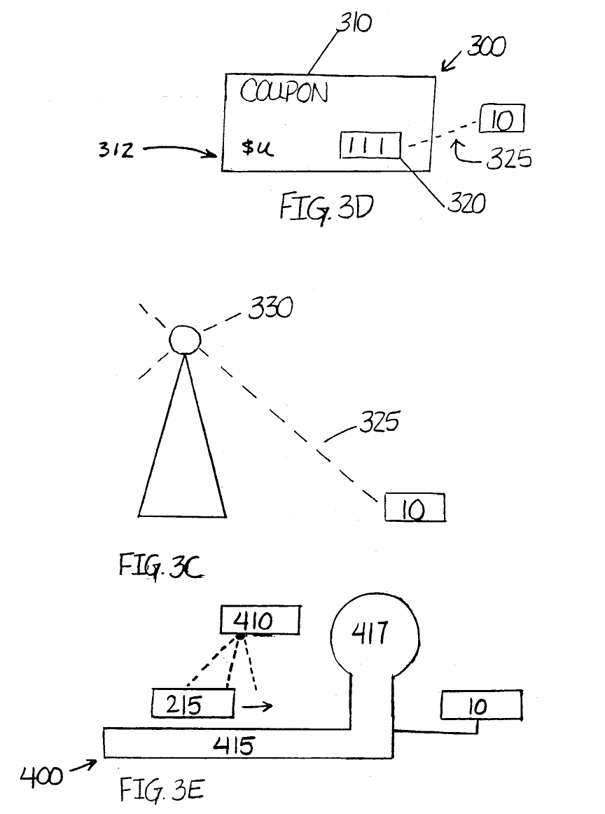

FIG. 3A shows a partial view of a retail store 100. Customer 210 shops in the store 100 having device 10 in his or her hand and pushes cart 212. Before shopping in the store a customer may obtain a wireless device 10. For example, customer 210 obtained wireless device 10 from a retail store, by completing an affinity or discount card application for the store. The application contained questions to collect customer demographic data, including name, birth date, income level, past buying patterns, geographic location, size of family, level of education, and job-related data.

After shopping and redemption of the advertising coupons from a plurality of devices 10, the data are compiled and sent to a data base of the retailer, manufacturer or market research center, as described below. The customer's data is used to evaluate the corresponding demographics, thereby providing the manufacturer with valuable marketing data on coupon program effectiveness and customer buying patterns.

A section of store 100 includes shelves 102 and 104, defining aisle 106 between the shelves 102 and 104. The store has a plurality of product areas, each corresponding to a respective product. Product Area 110 has laundry soap. (Refer to FIG. 3B) Product Area 160 has soup. Product Area 180 has frozen food, and so on.

FIG. 3B shows Product Area 110 having bottles of laundry soap of different brands 112, 114, and 116 grouped together on multiple shelves with no other product between any two bottles of laundry soap. Each bottle of soap of the same brand, such as soap 112, has a common UPC label, such as UPC 118, which is a group of parallel lines that encodes a number that uniquely identifies a brand of soap.

Each bottle of soap of the same brand, such as soap 112, also has a common character label 124, shown as “Soap A” in FIG. 3B. Similarly, other brands of soap, shown as 114 and 116 on FIG. 3B, have character labels shown as 126 and 128, and UPC labels shown as 120 and 122, respectively. Below each bottle of soap 112, 114, and 116 are shelf labels 130, 136, and 142. Each shelf label, such as label 130, has the name of the product 132 and the price of the product 134.

Each shelf label also has a UPC, such as UPC 133, for shelf label 130, as shown in FIG. 3B. The UPC for the shelf label has the same information as the UPC on the respective product. That is, the UPC 118 for Soap A has the same information as UPC 133 on shelf label 130.

Similarly, other Product Areas in the store 100, such as Product Areas 160 and 180, each have a set of respective products contiguously grouped together and a corresponding product station adjacent to the products. The respective units of a certain product have a common label, different than labels on units of other products, that uniquely identifies the certain product.

FIG. 3C shows a wireless signal 330 having electronic coupon information 325 being sent to device 10.

FIG. 3D shows a paper coupon 300 having a coupon name 310, a coupon discount amount 312, and a UPC 320. The paper coupon may be obtained from a newspaper, bulk-mailed advertising, or the like. Device 10 scans UPC 320 and receives electronic coupon data 325.

FIG. 3E shows checkout area 400 where the items selected for purchase 215 are scanned. A price for each item is determined depending on whether the wireless device contains coupon for the scanned product. The electronic coupons are redeemed by inserting wireless device 10 into checkout station 415 where a checkout clerk (not shown) scans each selected item past UPC reader 410. The electronic data 325 stored in memory 42 device 10 is downloaded and/or transmitted to a processor, computer, or data receiving device (not shown) coupled to station 415. The processor or data receiving device determines whether the scanned UPC information matches the electronic coupon information 325 that is stored in memory 42 of device 10. If the UPC electronic coupon information 325 that is stored in memory 42 of device 10. If the UPC information matches, then a price for the item is determined using the electronic coupon information 325 corresponding to the item, and the resulting price is displayed on display 417 of the checkout station 400. If the UPC information does not match, then the price of the item selected for purchase 215 is displayed based on such UPC information. All data scanned and/or downloaded is stored in the processor, computer, data receiving device, or the like.

Electronic Coupon Transfer (ECT)

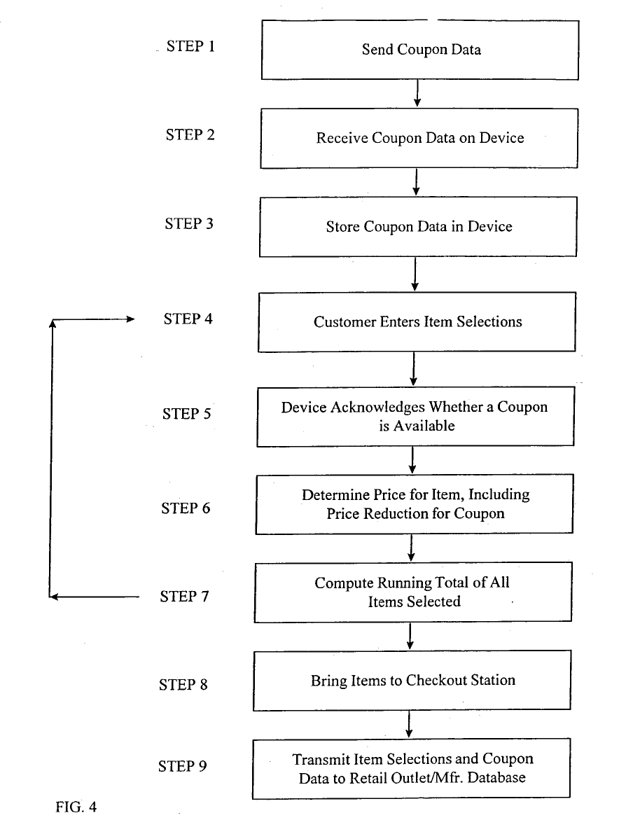

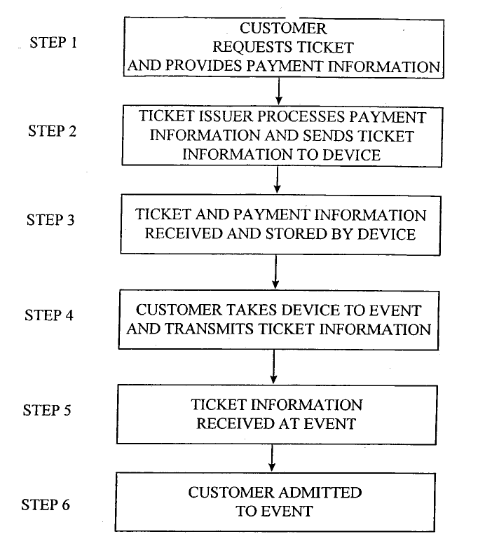

FIG. 4 shows the method of using the device for electronic coupons of this invention.

In Step 1, electronic coupon data are sent in the form of a wireless signal 330 from a manufacturer, retailer, or coupon issuer as shown in FIG. 3C.

In Step 2, the wireless signal 330 is received by device 10 as electronic coupon data 325. The device 10 may also receive electronic coupon data directly from the customer as shown in FIG. 3D.

In Step 3, the device 10 stores the electronic coupon data 325, received from a wireless signal 330 or directly scanned by customer, in memory 42 of the device 10.

In Step 4, the customer enters the items he or she wishes to purchase. These items may be entered as a grocery list on the alpha keypad 12 on device 10. Also, the items may be entered directly by the customer at the store 100. A customer, such as customer 210, brings the device 10 to a retail store 100 to enter items for purchase. At store 100, the customer removes products from shelves 102 and 104 and brings the products to checkout area 400. While shopping in store 100, customer 210, for example, carries his or her respective wireless device 10, and pushes a shopping cart to hold selected products. Customer 210 pushes cart 212. Customer 210, for example, shops in Product Area 110 of store 100, as follows. An item is selected for purchase in Product Area 110 and placed in cart 212. Then, customer 210 uses the scanning function of device 10 to scan the shelf label of the item selected for purchase. If brand of soap A 112 of Product Area 110 is selected, then he or she will scan UPC 133 of shelf label 130. The device 10 receives and stores the electronic coupon data 325. The customer thus shops throughout the aisles of store 100.

In Step 5, the device 10 acknowledges whether a coupon is available for the item selected. If a coupon is available, then the display 11 will show a plus (+) sign next to the item. If a coupon is unavailable for the item, then the display will show a minus (−) sign next to the item.

In Step 6, if a coupon is available the device will determine the price for the item selected by deducting the value of the coupon.

In Step 7, the device 10 will compute a running total of all items selected for purchase. Steps 4 through 7 are repeated as the customer shops throughout the product areas of store 100.

In Step 8, the customer brings the items selected for purchase in his or her cart to the checkout area 400.

At checkout area 400, the items selected for purchase 215 are scanned. A price for each item is determined depending on whether the wireless device contains coupon for the scanned product. More specifically, the customer redeems the electronic coupons, by inserting his or her wireless device into checkout station 415. For example, a customer, such as customer 210 in FIG. 3A, completes the purchase of his or her selected items by transferring items 215 from his or her cart 212 to area 400, and by inserting device 10 into checkout station 415. Subsequently, a checkout clerk (not shown) scans each selected item past UPC reader 410. A processor or the like (not shown) coupled to station 415 and reader 410 determines whether the scanned UPC information matches the electronic coupon information 325 that is stored in memory 42 of device 10. If the information matches, then a price for the item is determined using the electronic coupon information 325 corresponding to the item, and the resulting price is displayed on display 417 of the checkout station 400. Checkout station 415 scans and processes each item selected for purchase 215 in a similar manner.

In Step 9, the coupon redemption electronic data is transmitted and/or downloaded to a computer database of a retailer and/or manufacturer. Also, the data may be downloaded to a data receiving terminal.

In summary, the wireless device 10 of this invention includes receiving means 30 for data receiving by any electronic medium, including the Internet or E-mail, scanning means 32 for scanning paper coupons and advertising, a memory 42 and associated software for storing the electronic coupon and ticket information received by device 10, an alpha keypad 12 and a numeric keypad 14, and a series of buttons for engaging the calculator 16, calendar 20, search menu 18 and other functions of device 10. The method comprises the steps of sending coupon data wherein device 10 receives the coupon data and stores the data in memory 42 of device 10. A customer, such as customer 210, enters item selected for purchase. Device 10 first acknowledges whether a coupon is available, determines the price of the item selected including a price reduction for coupon, then computes a running total for all items. Customer repeats the item selection process until all items are selected and then brings items to checkout station. At the checkout station, the electronic coupons are redeemed, the information regarding customer's item selections are transmitted to a retail outlet and/or manufactures database or data receiving terminal.

Electronic Ticket Transfer (ETT)

FIG. 5 shows the method of using the device of this invention for electronic ticketing transfer (ETT).

In Step 1, a customer requests a ticket by making a telephone call, or by sending an Internet E-mail, to the ticket issuer. While requesting a ticket, the customer provides payment information from a credit card, debit card, wire transfer, or the like.

In Step 2, the ticket issuer processes the payment information provided by the customer and sends the electronic ticket information to device 10. The electronic ticket information may be sent via wireless transmission, radio wave transmission, the Internet, or E-mail, or the like.

In Step 3, the electronic ticket and payment information are received by device 10 and stored in the memory 42 of device 10. Upon receipt of electronic ticket information from a ticket issuer, the display of device 10 will notify the customer with a message of such receipt.

In Step 4, a customer takes device 10 to the event for which an electronic ticket was issued, such as a sporting event, or a concert, or the like.

In Step 5, the device 10 is engaged with means for transmitting the stored ticket information at the entrance and/or ticket gate of the event. The device 10 transmits and/or downloads the electronic ticket and payment information to another computer or data receiving terminal which receives the information and clears memory 42 of device 10.

In Step 6, the customer is admitted to the event.

Additional advantages and modifications will readily occur to those skilled in the art. The invention in its broader aspects is therefore not limited to the specific details, representative apparatus, and illustrative examples shown and described. Accordingly, departures may be made from such details without departing from the spirit or the scope of Applicants' general inventive concept. The invention is defined in the following claims.

18. A portable information storage device comprising:
a processing means configured to control the operation of said portable information storage device;
a communications module coupled to said processing means configured to receive information relating to advertising coupons from a coupon transmission source;
a storage unit coupled to said processing means configured to store said received information, and to store a unique device identifier code corresponding to said information storage device, so that said communications module receives coupon data transmitted from said coupon transmission source, wherein said received coupon data is associated with said device identifier code; and
a scanner coupled to said processing means configured to scan universal product codes displayed in connection with products stored in a supermarket in order to redeem said coupons via said portable information storage device, said scanner being configured to allow a consumer to scan printed coupon advertising, and store information related to said scanned printed coupon advertising in said storage unit for later redemption upon purchase of product advertised in said scanned coupon.

19. A portable information storage device as claimed in claim 18 wherein said communications module is a wireless data communication channel.

20. A portable information storage device as claimed in claim 19 wherein said wireless data communication channel is the internet.

21. A portable information storage device as claimed in claim 19 wherein said wireless data communication channel is e-mail transmissions.

22. A portable information storage device as claimed in claim 18 wherein said coupon transmission source further comprises a means to store said device identifier code and a demographic profile relating to each said device identifier code.

23. A portable information storage device as claimed in claim 22 wherein said demographic profile is updated based on coupons used by a consumer associated with said device identifier code.

24. A portable information storage device as claimed in claim 22 wherein said demographic profile is updated based on coupons deleted by a consumer associated with said device identifier code.

25. A portable information storage device as claimed in claim 22 where in said coupon transmission source delivers said information relating to advertising coupons based upon an updated version of said demographic profile.

26. A portable information storage device as claimed in claim 18 wherein said portable device further comprises an input means configured to receive a desired shopping list from a consumer and further configured to compare items entered on said list with said coupons received from the transmission from said coupon transmission source.

28. A portable information storage device as claimed in claim 18 wherein said coupon transmission source broadcasts said information relating to advertising coupons to said communications module.

29 A portable information storage device comprising:
a processing means configured to control the operation of said portable information storage device;
a communication module coupled to said processing means configured to receive information relating to an electronic ticket corresponding to a ticket issuer;
a storage unit coupled to said processing means configured to store said received ticket information; and
an interface means coupled to said processing means configured to allow said portable information storage device interact with a system located at a point of entry location relating to said ticket, said interface means upon receiving an authorization code at said point of entry allows a user of said portable device to enter through said point of entry location and, invalidates said stored ticket information.
